(19) United States
(12) Patent Application Publication
(10) Pub. No.: US 2003/0228988 A1
(43) Pub. Date: Dec. 11, 2003

(54) Ozone solutions

(75) Inventors: Lars Kloo, Taby (SE); Margareta Eriksson, Sollentuna (SE)

Correspondence Address: Stanley R. Moore, Esq., Jenkens and Gilchrist, P.C., 3200 Fountain Place, 1445 Ross Ave., Dallas, TX, 75202, US

(73) Assignee: Otre AB

(21) Appl. No.: 10/256,498

(22) Filed: Sep. 27, 2002

(30) Foreign Application Priority Data
Jun. 11, 2002 (SE) 0201762-2

(51) Int. Cl. C11D 17/00

(52) U.S. Cl. 510/161; 510/417

(57) ABSTRACT

The invention relates to a method to stabilise ozone in solution. The invention also relates to cleaning compositions using the stabilised ozone solutions that may be used to remove all types of unwanted substances and bacteria, while being stable and having no negative impact on the environment.

### TECHNICAL FIELD OF THE INVENTION

The present invention relates to stabilised solutions of ozone, more particularly, to ozone confined in regions of a hydrophobic phase within an aqueous phase. The present invention also pertains to stabilised solutions of ozone which can be used in cleaning systems for removal of for example hydrophobic substances in water solution, bloodstains, rust, calcium carbonate (limestone), other calcium-containing precipitates, biofilm, cleaning and sterilising equipment used in biological and medical applications, and for wound care.

### BACKGROUND OF THE INVENTION

New cleaning processes are continuously being developed. In order to optimise the process regarding environmental effects and cost it is desirable to meet certain criteria. The method should be efficient and only use a minimum amount of chemicals. It is also beneficial if many different types of unwanted substances and chemicals can be removed in the same process. The toxicity and environmental effects of the chemicals used should also be taken into account, and they should not form toxic by-products. The following chemicals are already well known and used in the industry for cleaning.

Surfactants form micelles or other mesomorphic states in water solutions with the hydrophobic part pointing into the micelle and the hydrophilic part pointing outwards. If hydrophobic dirt is present, e.g. oil, this will dissolve in the centre of the micelle where it is protected against the water. The micelles containing the hydrophobic dirt can then easily be rinsed away. Surfactants can therefore successfully be used to remove hydrophobic substances in water solution.

Organic acids, such as carboxylic acids like acetic or oxalic acid are used in industry to dissolve for instance bloodstains, rust, calcium carbonate as well as other calcium containing precipitates.

Ozone is a known powerful sterilant with many advantages, it has high and fast kinetics, it is not selective (like antibiotics) and it forms no toxic by-products (in contrast to for example chlorine).

It is also known to use cleaning solutions containing active cleaning substances encapsulated in a solution so as to form emulsions or microemulsions.

Numerous patents have been issued on cleaning systems having combined some of the above-mentioned components, a few of which are discussed below

U.S. Pat. No. 5,962,388 discloses acidic aqueous cleaning compositions, and particularly hard surface cleaning compositions, which contain alkyl or aryl sulphonate surfactant, selected hydrophobic cleaning solvent, polycarboxylic acid, and aqueous solvent system in solution and/or a micellar phase, the pH being between 2 and 4. These cleaning compositions have excellent soap foam removal and hard water deposit removal properties. Optionally, they also contain additional anionic sulphate surfactant, cationic surfactant, peroxide and/or hydrophilic polymer.

U.S. Pat. No. 5,827,447 discloses a liquid bleaching agent composition comprising hydrogen peroxide, a surfactant and a bleach activator capable of yielding an organic peracid when reacted with hydrogen peroxide.

U.S. Pat. No. 3,964,994 discloses hydrogen peroxide-containing micellar dispersions, i.e. systems containing peroxides, aqueous medium, and a surfactant. The hydrogen peroxide-containing micellar dispersions are then mixed with the liquid media in which hydrogen peroxide is to be used as a reactant or catalyst to effect intimate contact and dispersions of the hydrogen peroxide within the liquid media.

While ozone is a potent agent for applications as those indicated above, it is not previously known to stabilise ozone in solution for sufficient time to render it useful for such applications

### SUMMARY OF THE INVENTION

In view of the problems associated with stabilising ozone in solution there is a need for a method of stabilising ozone with which ozone can be stabilised for various periods of time, but in particular for extended use.

So far, the prior art has not presented any solution to this problem.

Therefore, one object of the invention is to provide a method to stabilise ozone in solution for various periods of time, as well for extended use.

The present invention achieves this object by stabilising ozone in a hydrophilic environment by using surfactants, an emulsion of a hydrophobic phase, or a combination of both.

Another object according to the present invention is to provide cleaning compositions using the stabilised ozone solutions, which cleaning solutions efficiently removes essentially all types of unwanted substances and bacteria, while being stable and having no negative impact on the environment.

None of the prior art compositions combine the qualities of surfactants, organic carboxylic acids and ozone, and such a combination would be a very powerful cleaning system. It would remove hydrophobic substances (biofilm), calcium-containing precipitates, and also make the product sterilising.

To this point, the idea of combining these three potent cleaning agents into one that is capable of removing all types of unwanted substances and bacteria has not been presented. Stabilisation of a solution of ozone and surfactants has also not been presented.

In a further aspect the present invention provides a cleaning solution comprising the inventive compositions as the active components, used for removal of for example hydrophobic substances, bloodstains, rust, calcium carbonate, other calcium containing precipitates, biofilm and bacteria from an object. The cleaning solution can also be used for cleaning and sterilising equipment used in biological and medical applications, and for wound care.

In a further aspect the invention also provides a method of removing hydrophobic substances, bloodstains, rust, calcium carbonate (limestone), other calcium-containing precipitates, and biofilm, or any other type of dirt from an object, the method comprising the step of applying to said object a stabilised solution of ozone in water, wherein the ozone is confined in regions of a hydrophobic phase within a hydrophilic phase.

In a further aspect the invention also provides a method of cleaning and sterilising equipment used in biological and medical applications, the method comprising the step of applying to said equipment a stabilised solution of ozone in water, wherein the ozone is confined in regions of a hydrophobic phase within a hydrophilic phase

In a further aspect the invention also provides a method of cleaning and sterilising a wound, the method comprising the step of applying to said wound a stabilised solution of ozone in water, wherein the ozone is confined in regions of a hydrophobic phase within a hydrophilic phase.

### BRIEF DESCRIPTION OF THE DRAWINGS

The present invention will now become more fully understood from the detailed description given herein, wherein reference is made to the accompanying drawings, in which,

FIG. 1 compares the ozone concentration (as a function of time) in a solution of pure ozone and an ozone solution where SDS (sodium dodecyl sulphate) was added after 5.5 minutes,

FIG. 2 compares the ozone concentration (as a function of time) in a solution of pure ozone and an ozone solution where dodecyl b-D-maltoside was added after 7 5 minutes,

FIG. 3 compares the ozone concentration (as a function of time) in a solution of pure ozone and an ozone solution where dodecyl trimethyl ammonium was added after approximately 5 minutes,

FIG. 4 compares the ozone concentration (as a function of time) in an aqueous ozone solution at two different concentrations of SDS,

FIG. 5 compares the ozone concentration (as a function of time) in a solution of pure ozone and an ozone solution where an acetate and acidic acid solution was added after 5 minutes,

FIG. 6 compares the ozone concentration (as a function of time) in a solution of pure ozone and an ozone solution where an oxalate and oxalic acid solution was added after 7 minutes,

FIG. 7 compares the ozone concentration (as a function of time) in a solution of pure ozone at pH 5 and an ozone solution containing sodium acetate and SDS at pH 7,

FIG. 8 compares the ozone concentration (as a function of time) in a solution of pure ozone at pH 5 and an ozone solution containing sodium oxalate and SDS at pH 6,

FIG. 9 shows the ¹³C NMR spectrum of pure oxalate,

FIG. 10 shows the ¹³C NMR spectrum of oxalate treated with ozone,

FIG. 11 shows the ¹³C NMR spectrum of pure acetate,

FIG. 12 shows the ¹³C NMR spectrum of oxalate treated with ozone.

### DETAILED DESCRIPTION OF PREFERRED EMBODIMENTS

The present inventors have filed several patent applications covering systems, devices and methods using the sterilising effect of ozonised water solutions at exact concentration.

In addition to this sterilising effect, the present invention provide stabilised solutions of ozone, as well as cleaning solutions containing these stabilised solutions of ozone. These solutions can for example suitably be used for removing various types of dirt, cleaning and sterilising equipment used in biological and medical applications, and wound care.

The primary object of the invention is to provide a method to stabilise ozone in solution for various periods of time, but in particular for extended use.

The present invention achieves this object by stabilising ozone in a hydrophilic environment by using surfactants. Since surfactants have a hydrophobic and a hydrophilic part, it is possible in a hydrophilic environment to create surfactant microspheres having their hydrophilic parts pointing outwards towards the hydrophilic environment and their hydrophobic part pointing towards the centre of the microspheres. In a mixture of such microspeheres and ozone in a hydrophilic environment, the hydrophobic ozone will take refuge to said spheres, whereby the depletion rate of ozone in a hydrophilic environment can be significantly reduced.

In one embodiment of the present invention, the surfactants are present in the solution in a mesomorphic phase or a liquid crystalline phase. The surfactants may be present in the solution as linear chains or as a phase that is, lamellar, hexagonal, cubic and micellar, or any other mesomorphic state.

The present invention surfactants are selected from the group comprising anionic, non-ionic, neutral or zwitterionic and cationic surfactants, and at least one surfactant is selected from the group comprising sodium dodecyl sulphate, dodecyl b-D-maltoside, dodecyl trimethyl ammonium acetate, 1,2-Dihexadecanoyl phosphatidylcholine, polyethylene glycol p-octylphenyl ether, betaine or sulphobetaine surfactants.

In another embodiment of the present invention, the ozone is stabilised in a hydrophilic environment by creating an emulsion or a microemulsion of a hydrophobic phase, e.g. oil. For short time stabilisation this can be done by sonication of a mixture of ozone, oil, and a hydrophilic phase. For extended ozone stability, a surfactant is also added to the mixture.

In a second aspect of the present invention, which is based on the discovery that it is possible to combine three potent cleaning agents, namely surfactants, acids, and ozone, into one solution that has the ability to remove essentially all types of unwanted substances and bacteria, while maintaining the cleaning composition in a stable state, there is provided a cleaning composition.

Thus, in order to be able to efficiently remove calcium containing precipitates a cleaning composition is provided using a stabilised ozone solution and at least one acid and/or the salt thereof. The at least one acid is selected from the group of organic acids such as oxalic acid, acetic acid, or other carboxylic acids.

Both the ozone, the surfactants and the acids have an effect on and remove biofilm from objects or surfaces.

In a further aspect the invention provides a method of removing hydrophobic substances, bloodstains, rust, calcium carbonate (limestone), other calcium-containing precipitates, and biofilm, or any other type of dirt from an object; cleaning and sterilising of equipment used in biological and medical applications; and wound care, the method comprising the step of applying to said object a stabilised solution of ozone in water, wherein the ozone is confined in regions of a hydrophobic phase within a hydrophilic phase.

The cleaning composition according to the present invention further comprises a biocompatible solvent, such as water or a hydrocarbon, or any other biocompatible solvent, including but not limited to alcohol solvents such as ethanol, with which the objects of the present invention may be achieved. However, water is preferred. The cleaning solution may also comprise auxiliary agents, such as dispersion agents, stabilisers, buffers, co-surfactants, or co-polymers.

In the cleaning composition according to the present invention the molar ratio between the surfactant and ozone is 1:1 to 10000:1, preferably 10:1 to 1000:1, and more preferably 100:1 to 1000:1 The surfactant can constitute from about 0.05 wt % to about 40 wt % of the weight of water in the solution.

The inventive cleaning compositions are used at 0-100° C., and more preferably at 10-50° C.

For maximum efficiency, the pH value in the cleaning solutions is below 5, and preferably below 4.

Now a more detailed description will be given of how the ozone stability, the compatibility of the active substances and their efficiency to remove dirt was determined.

Ozone Stability in the Presence of SDS (Anionic Amphiphile)

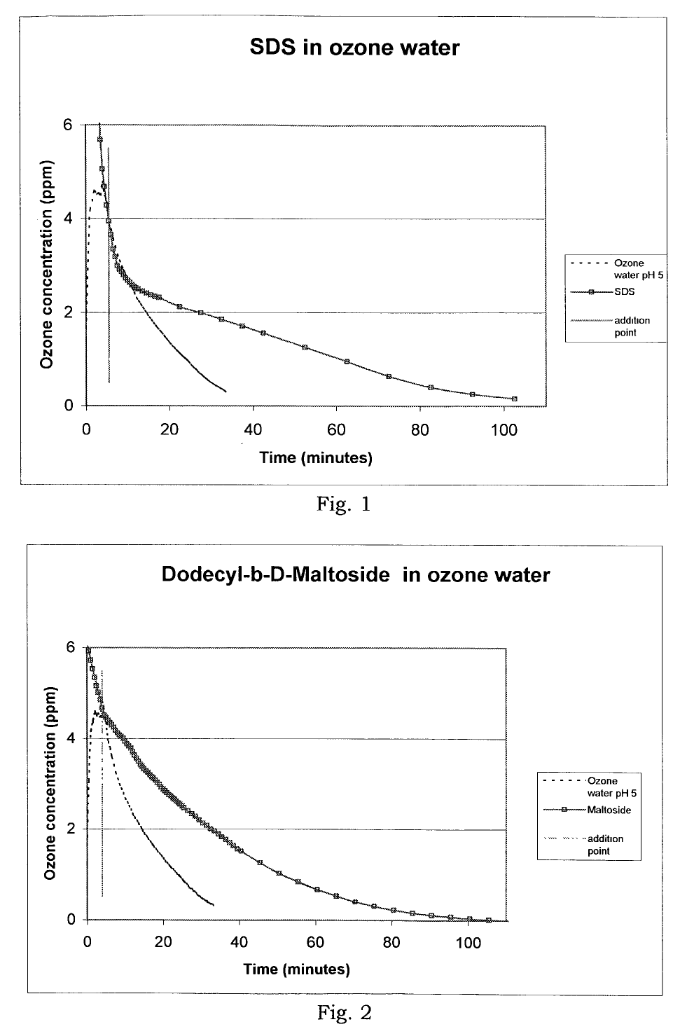

In FIG. 1 it can be seen that an anionic amphiphile such as SDS has a positive effect on the stability of ozone. It prolongs the lifetime of ozone three to four fold as compared with a pure ozone solution at approximately the same pH.

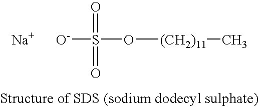

When the concentration of SDS is high, SDS is predominantly present in the form of linear molecules. When the concentration decreases the surfactants will predominantly change aggregation state into micelles In FIG. 4, when using the higher surfactant concentration, a significant increase in the lifetime of ozone can be seen. Aggregation of the surfactant will also change with temperature.

One of the surfactants, SDS, was tested at two different concentrations: Low concentration (0.1 mM), where the surfactant exists in micellar aggregates, and high concentration (200 mM), where the surfactant exists in the form of both micelles and linear (paraffinic) chains. Phase diagrams (not shown) show that SDS can occur in other forms as well, such as hexagonal, lamellar etc. However, in order to obtain these states the surfactant solution has to be heated.

The experiments show that ozone is depleted much faster in the presence of SDS in the state of both micelles and paraffinic chains than when SDS exhibits a predominantly micellar constitution, i.e. practically no paraffinic chains.

Ozone Stability in the Presence of Dodecyl b-D-maltoside (Neutral Amphiphile)

As can be seen in FIG. 2, a non-ionic amphiphile such as dodecyl b-D-maltoside has a stabilising effect on ozone. The depletion rate of ozone is about half the depletion rate of pure ozone solution at approximately the same pH.

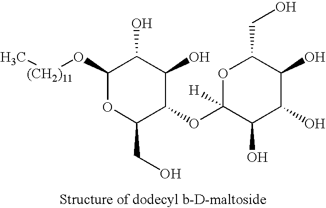

Ozone Stability in the Presence of Dodecyl Trimethyl Ammonium Acetate (Cationic Amphiphile)

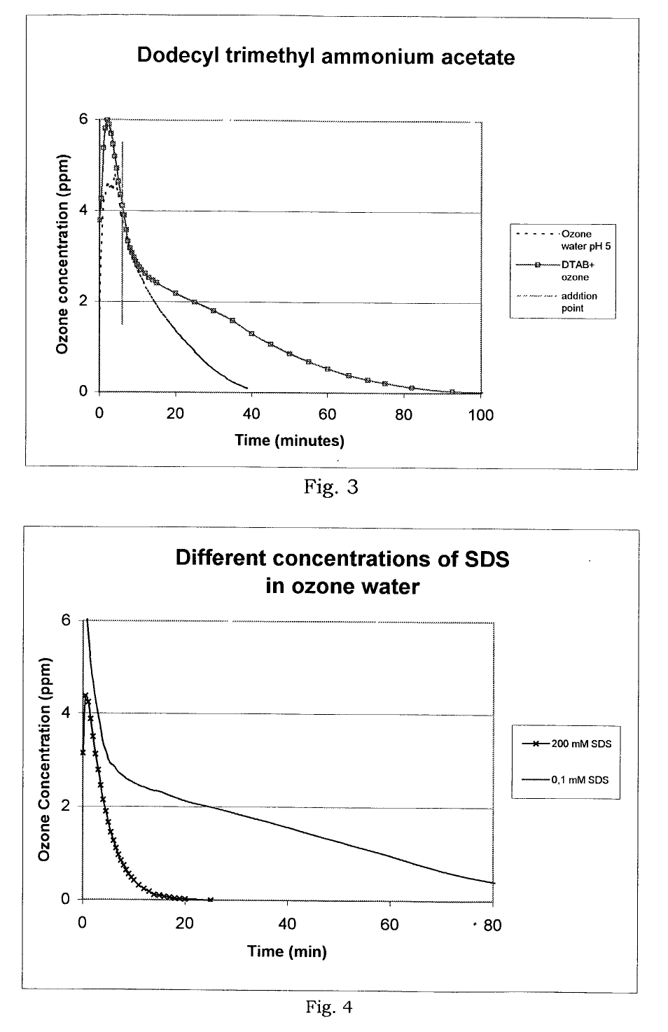

As can be seen in FIG. 3, also a cationic amphiphile such as dodecyl trimethyl ammonium acetate has a stabilising effect on ozone. The lifetime time of ozone can be increased by approximately a factor of two when dodecyl trimethyl ammonium acetate is present in the solution

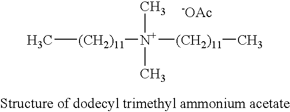

The stability of ozone with respect to the different amphiphiles should not be directly compared, since pH is slightly different in the different experiments (pH has a very significant effect on the decomposition rate of ozone, since the rate-limiting steps involve reaction with OH⁻). Furthermore, as mentioned above, the amphiphiles can be aggregated in different types of mesomorphic states or liquid crystalline phases, which can affect their efficiency in stabilizing ozone

Ozone Stability in the Presence of Acetic and Oxalic Acid

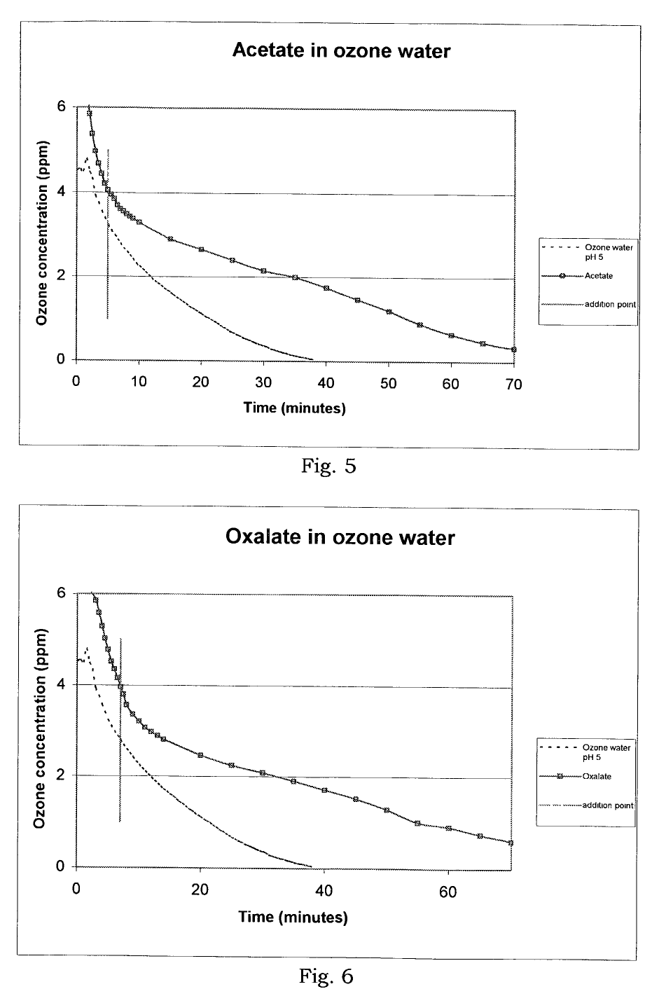

As can be seen when studying FIGS. 5 and 6 (the graphs should not be directly compared as the pH varies slightly between the experiments), both oxalate and acetate have a positive effect on ozone stability and can therefore be used in a cleaning solution containing ozone without negatively influencing the stability of ozone, i.e. increasing the ozone depletion rate

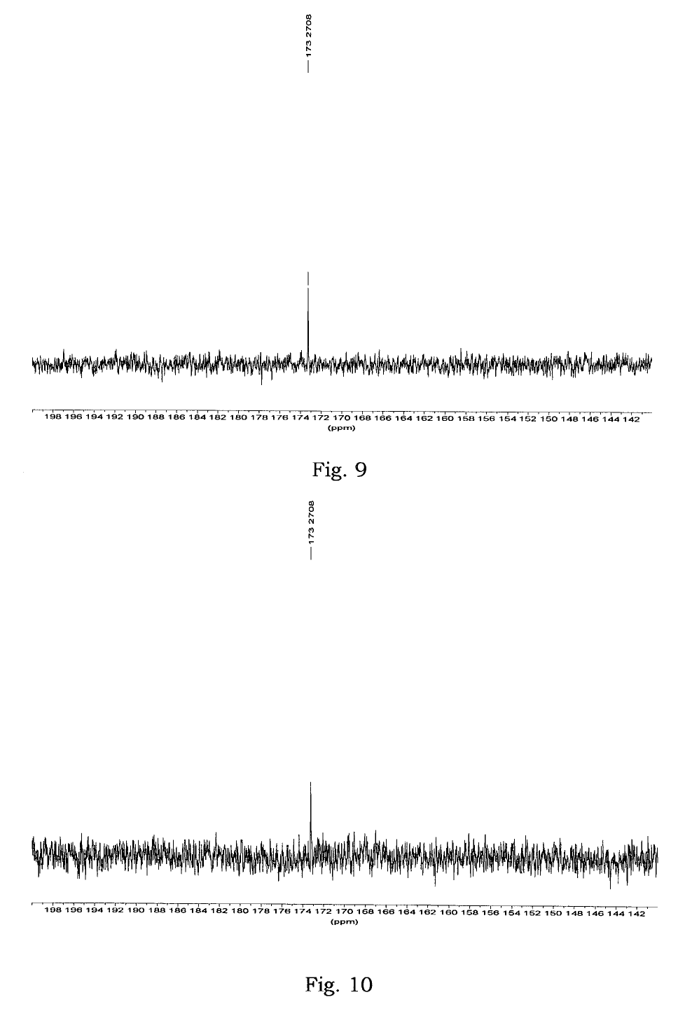

The aqueous solutions of the acids were analysed using ¹³C NMR and IR spectroscopy before and after treatment with ozone. FIGS. 9-12 show that no decomposition products have evolved after having mixed acids and the ozone, thus implicating that they do not react with each other.

The observation that oxalic acid does not react with ozone is not surprising since oxalate is being discussed as one of the end decomposition products when using an ozone aqueous purification systems for the treatment of biomass. For acetate, the same reaction pattern can be verified when studying the literature within the field, where it is mentioned to be an inhibitor of ozone depletion

Instead of using an acid, it is also possible to use its corresponding salt. In the case of oxalic and acetic acid that would be oxalate and acetate, respectively. By adding an acid or its salt to the cleaning solution a double action is achieved through acidification and complexation. The main effect is achieved by the lowering of the pH, but organic anions, such as oxalate and acetate, also enhances the dissolution process by complex formation.

Ozone Stability in the Presence of Both a Surfactant and an Acid Solution

An additional test was made to verify that the solution of mixed surfactant and acetate or oxalate would not affect the ozone stability. All three surfactants were tested with both oxalate and acetate, but only the results from SDS are presented here. However, the other surfactants show similar behaviour. It should be noted that the pH values for the test with acetate and oxalate were different (pH 7, respectively pH 6) and should therefore not be compared directly. The pure ozone solution has a lower pH (pH 5) and should therefore only be seen as a reference Higher pH leads to faster ozone decomposition.

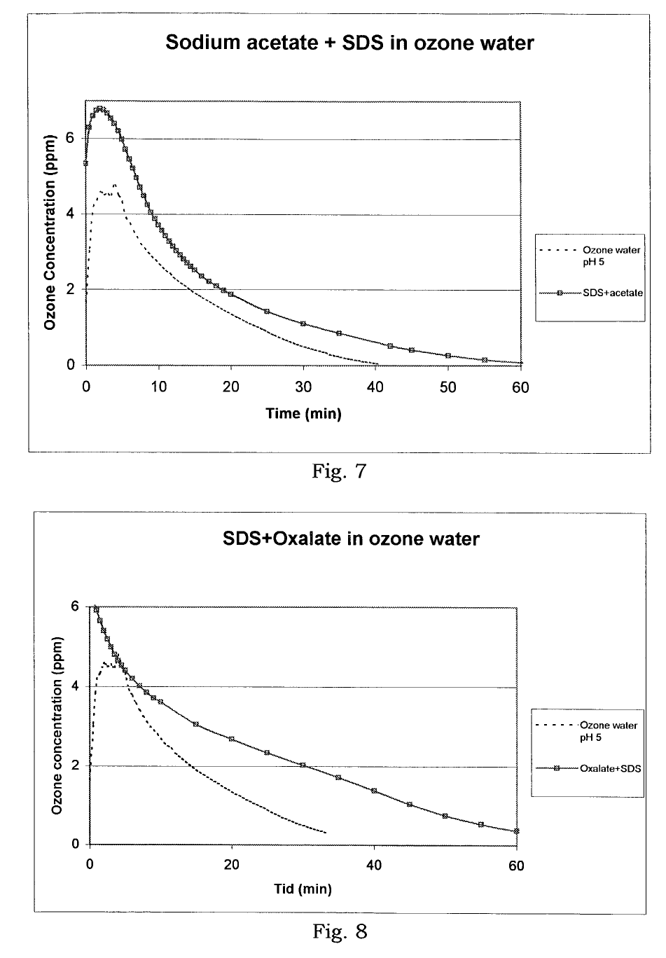

As can be seen in FIGS. 7 and 8, mixing SDS with sodium acetate and oxalate, respectively, does not increase the rate of decomposition of ozone. Instead, it indicates that a stabilisation occurs.

Ozone Stability in Microemulsion

Experiments showed that a microemulsion containing aniseed oil and SDS also could have a stabilising effect on ozone. The depletion rate of ozone is about half compared to pure water at the same pH.

Removal of Calcium Carbonate

When preparing a solution containing a saturated aqueous solution of CaCO₃, solid CaCO₃, and a solution of SDS, acetic acid, and sodium acetate, the CaCO₃ started to dissolve and the solution was clear after approximately 15 seconds. Thus, the surfactant and acid solution dissolves CaCO₃. However, for a successful result it is crucial to have an acidic solution This holds also when ozone is present in the cleaning solution.

Removal of Biofilm

In order to ensure that the solution of surfactant and acetic or oxalic acid, as well as ozone would be efficient towards a biofilm, a solution of acid and SDS was mixed with a vegetable oil. The test showed that the surfactant solution, after being mixed with the acid and/or ozone, still had the ability to dissolve hydrophobic substances (in this case vegetable oil. Thus, it retains an effect against biofilm.

Thus, the present invention provides a cleaning solution combining three potent cleaning substances, namely ozone, surfactant and acetic or oxalic acid, which until now have not been shown to coexist without decomposing each other. The cleaning solution according to the present invention also exhibits improved ozone lifetime compared with a pure ozone solution Furthermore, the inventive cleaning solution has also been shown to dissolve hydrophobic substances, i.e. exhibiting an ability to remove bio film, and successfully dissolve limestone

### EXAMPLES

The present invention will now be described more in detail with reference to the non-limiting examples presented below.

General Details

Deionised water was used in all aqueous solutions. All experiments were made at room temperature, ˜23° C. The variation of the temperature between the different experiments was relatively small and should not have any significant effect on the outcome. All tests were made at least twice in order to verify the reproducibility.

The following procedure was applied in the analysis of ozone concentration. Magnetic stirrer was used to obtain a homogeneous solution. The ozone concentration, pH and temperature were registered every 30 seconds, until ozone no longer could be detected.

The following equipment was used during the experiments:

| | |
|---|---|
| Ozone electrode: | Fisher Rosemount 499A |
| pH-electrode: | ORION 9101SCE |
| Thermometer: | ORION 917006 |
| Ozone generator (water): | Otre AB, 2000-1L |
| Ozone generator (air): | BMT Messtechnik, BMT802X |
| Ozone analyser (air): | BMT Messtechnik, BMT963 |
| IR-spectrophotometer: | BIO-RAD, 375C |
| NMR: | Bruker, DMX500 |

### Example 1

Ozone Stability in the Presence of Different Surfactants

An aqueous ozone solution with a concentration of approximately 6 ppm was tapped directly from the ozone water generator into a beaker. The ozone electrode was used to register the changes in concentration. The surfactants (SDS, dodecyl b-D-maltoside, and dodecyl trimethyl ammonium acetate) were added to the ozone solution after roughly 6 minutes. The concentration of the surfactants was approximately 0.1 mM.

The cationic surfactant dodecyl trimethyl ammonium acetate used in this experiment had from the beginning (as commercialised) a different anion, namely Br⁻. However, the bromide reacted directly with ozone, and was therefore removed by metathetical reaction (in principal, a reaction between two salts where the anions change places, generally having its drive force in the fact that one of the products is insoluble in the solvent used) 0.1 g surfactant (2.16×10⁻⁴ mol Br⁻) was mixed with a 100 ml aqueous solution containing 0.05 g AgAc (3.0×10⁻⁴ mol Ag⁺). The solution was filtered to remove the formed precipitate, AgBr.

The results of the ozone stability test are shown in FIGS. 1-3, namely that the added surfactants increase the lifetime of ozone by a factor 2.

### Example 2

Ozone Stability in the Presence of Different Concentrations of SDS

An aqueous ozone solution with a concentration of approximately 6 ppm was tapped directly from the ozone generator into a beaker. The ozone electrode was used to register the changes in concentration. SDS was added directly to the aqueous ozone solution, yielding solutions having concentrations of 0.1 mM and 200 mM with respect to SDS The result is seen in FIG. 4, namely that the higher concentration of SDS increases the lifetime of ozone by a factor 5 compared with the lower concentration.

### Example 3

Ozone Stability in the Presence of Acetic and Oxalic Acid

An aqueous ozone solution with a concentration of approximately 6 ppm was tapped directly from the ozone generator into a beaker. The ozone electrode was used to register the changes in concentration. Acetic or oxalic acid was added directly to the solution. The concentration of the acids was approximately 0.01M. The results are shown in FIGS. 5 and 6, namely that the addition of the acids to the ozone solution increase the lifetime of the ozone by a factor 2.

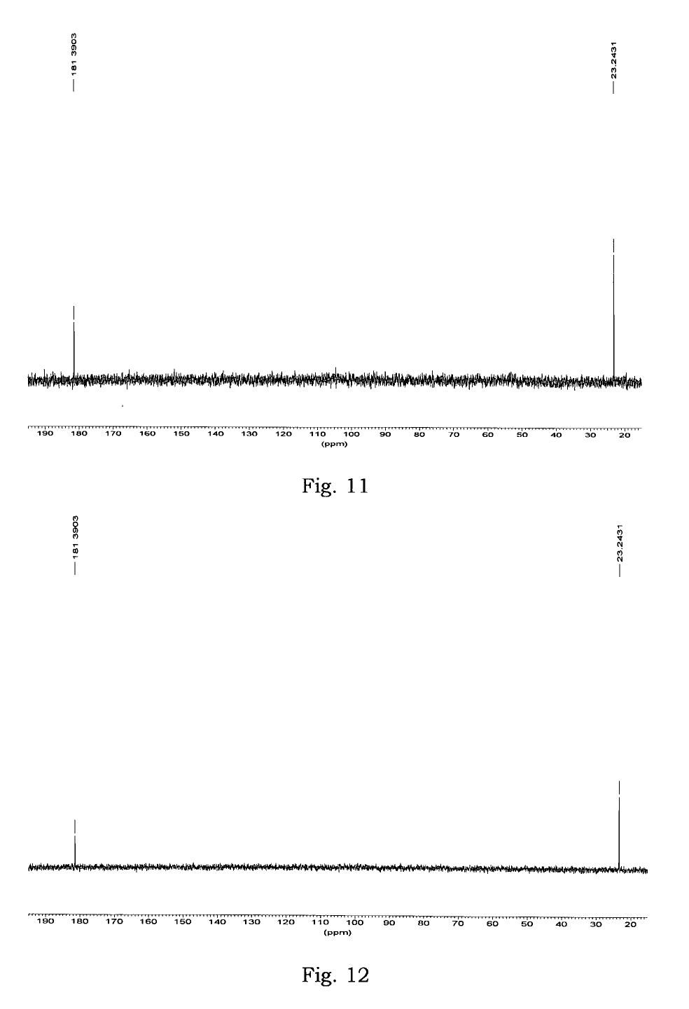

In order to verify that the organic acids had not been oxidised by ozone an additional test was made 300 ml of an aqueous solution of acid (0.1M, 30×10⁻³ mol) was bubbled with ozone for five hours. The gaseous concentration of ozone was ˜100 g/m³. The airflow was 0 2 l/minute, which gives 1.2 g ozone/h (1.7×10⁻³ mol ozone/h). The aqueous solutions were analysed using ¹³C NMR and IR spectroscopy before and after treatment with ozone. The results are shown in FIGS. 9-12, namely that the peaks in the spectrograms of the pure acid solutions (FIGS. 9 and 11) had not changed their appearance after prolonged treatment with ozone (FIGS. 10 and 12)

### Example 4

Ozone Stability in the Presence of Surfactant and Acid Solution

An aqueous ozone solution with a concentration of approximately 6 ppm was tapped directly from the ozone generator into a beaker. The ozone electrode was used to register the changes in concentration. Acetic acid respective oxalic acid together with the surfactant was directly added to the ozone solution. The concentration of the acids was approximately 0.01 M and the concentration of the surfactants was 0.1 mM. The results are shown in FIGS. 7-8, namely that the lifetime of ozone increased with at least 50% compared with a pure ozone solution

### Example 5

Ozone Stability in Microemulsion

A microemulsion containing approximately 0.2 wt % aniseed oil and 2 wt % SDS was manufactured. Ozone was introduced in the microemulsion in a concentration of approximately 4 ppm. By continuous measurement of the ozone concentration, the experiment showed that the emulsion had a positive effect on the ozone stability. Using a microemulsion, the depletion rate of ozone was about half the depletion rate in pure water at the same pH.

### Example 6

Removal of Calcium Carbonate

An aqueous solution was saturated with CaCO₃ and filtrated. The solution (20 ml) was poured into a beaker and 0.05 g CaCO₃ was added. Another solution of SDS (1 mM), acetic acid (0.5 M), and sodium acetate (0.5 M) was prepared, and 5 ml was added to the first solution. The CaCO₃ started to dissolve and the solution was clear after approximately 15 seconds When including ozone in the cleaning solution, the ozone concentration used was approximately 4 ppm.

### Example 7

Removal of Biofilm

In order to ensure that the solution of surfactant and acetic or oxalic acid would be efficient towards biofilm a test was made as follows:

A 20 ml solution of 10 mM acid and 7 mM SDS was poured into a beaker with a magnetic stirrer. Rape oil (brand Zeta) was dropped into the solution. At large excess of oil in comparison to the surfactant, the surfactant acid solution started to have difficulty dissolving the oil. When including ozone in the cleaning solution, the ozone concentration used was approximately 4 ppm

What is claimed is:

1. A solution of ozone, wherein the ozone is present in a hydrophilic phase comprised within a hydrophobic phase.

2. The solution of claim 1, wherein said hydrophobic phase comprises at least one surfactant.

3. The solution of claim 2, wherein the surfactant is present in the solution either in a mesomorphic state or a liquid crystalline phase.

4. The solution of claim 2, wherein the surfactant is present in the solution as linear chains or as a phase that is lamellar, hexagonal, cubic, and micellar.

5. The solution of claim 2, wherein the at least one surfactant is selected from the group consisting of anionic, non-ionic, neutral and cationic surfactants.

6. The surfactant of claim 2, wherein the surfactant is selected from the group consisting of sodium dodecyl sulphate, dodecyl b-D-maltoside, dodecyl trimethyl ammonium acetate, 1,2-Dihexadecanoyl phosphatidylcholine, polyethylene glycol p-octylphenyl ether, betaine or sulphobetaine surfactants.

7. The solution of claim 1, wherein said hydrophobic phase comprised within said hydrophilic phase is an emulsion or a microemulsion

8. The solution of claim 1, further comprising at least one acid or a salt thereof.

9. The solution of claim 8, wherein the acid is an organic acid.

10. The solution of claim 9, wherein said organic acid is a carboxylic acid.

11. The solution of claim 10, wherein said carboxylic acid is selected from the group consisting of oxalic acid and acetic acid.

12. The solution of claim 1, further comprising solvents such as water, hydrocarbons, or other biocompatible solvents.

13. The solution of claim 1, further comprising auxiliary agents, such as dispersion agents, stabilisers, buffers, co-surfactants or co-polymers.

14. The solution of claim 2, wherein the molar ratio between the surfactant and ozone is 1:1 to 10000:1, preferably 10:1 to 1000:1, and more preferably 100:1 to 1000:1.

15. The solution of claim 2, wherein the surfactant is present at a range of about 0.05 wt % to about 40 wt %.

16. The solution of claim 1, wherein the solution is used at 0-100° C., and more preferably at 10-50° C.

17. The solution of claim 1, wherein the pH in the solution is below 5, and preferably below 4.

18. A cleaning solution comprising a solution according to claim 1 as the active component

19. A cleaning solution according to claim 18, wherein said regions of hydrophobic phase comprise at least one surfactant, the molar ratio between the surfactant and ozone being 1.1 to 10000.1, preferably 10:1 to 1000:1, and more preferably 100:1 to 1000:1, wherein the surfactant constitutes up to 40 wt % of the weight of water in the solution, said cleaning solution further comprising an organic acid, and optionally further comprising auxiliary agents, which cleaning solution preferably is used at 10-50° C., and wherein the pH in the cleaning solution is below 5, and preferably below 4.

20. A method of removing stains from an object comprising,
applying to said object a solution of ozone, wherein the ozone is present in a hydrophilic phase comprised within a hydrophobic phase.

21. A method of cleaning and sterilising equipment used in biological and medical applications comprising,
applying to said equipment a solution of ozone, wherein the ozone is present in a hydrophilic phase comprised within a hydrophobic phase.

22. A method of cleaning and sterilising a wound comprising,
applying to said wound a solution of ozone, wherein the ozone is present in a hydrophilic phase comprised within a hydrophobic phase.
